(19) United States
(12) Patent Application Publication
(10) Pub. No.: US 2019/0182115 A1
(43) Pub. Date: Jun. 13, 2019

(54) OPTIMIZATION OF DISTRIBUTED DATA STORAGE SYSTEMS

(71) Applicant: Datomia Research Labs OU, Tallinn (EE)

(72) Inventors: Murray B Wilshinsky, Jerusalem (IL); David Yanovsky, Tallinn (EE); Teimuraz Namoradze, Tallinn (EE)

(21) Appl. No.: 16/179,493

(22) Filed: Nov. 2, 2018

Related U.S. Application Data
(60) Provisional application No. 62/580,466, filed on Nov. 2, 2017.

(51) Int. Cl. H04L 12/24; G06F 3/06; G06Q 10/06

(52) U.S. Cl. CPC H04L 41/0823; G06F 3/0632; H04L 41/5025; H04L 41/5032; H04L 41/22; G06F 3/061; G06F 3/0653; G06F 3/067; G06F 3/0607; G06F 3/0614; G06Q 10/0635

(57) ABSTRACT

Optimization of a distributed data storage system includes the steps of: identifying parameters relevant to the distributed data storage or relevant to or set by a user or owner of said data; obtaining data for the parameters to define aspects of the distributed data storage or the user or owner of the data; analyzing the data for the parameters to determine the optimum characteristics of said distributed data storage; and based on the analyzed data for the parameters initially configuring a distributed data storage system or re-configuring an existing distributed data storage system, wherein distributing data in said distributed data storage system including: separating a data file into multiple discrete pieces, and dispersing the pieces among multiple storage units, wherein no one storage unit has sufficient data to reconstruct the data file.

### CROSS-REFERENCE TO RELATED PATENT APPLICATIONS

This application is based on and claims priority to U.S. Provisional Patent Application 62/580,466, filed Nov. 2, 2017, the entire contents of which is incorporated by reference herein as if expressly set forth in its respective entirety herein.

### FIELD OF THE INVENTION

This invention generally relates to optimization of distributed data storage systems.

### SUMMARY OF THE INVENTION

In particular, this invention generally relates to a dashboard used in conjunction with a distributed data storage system in order to quantify and mitigate perceived risks and/or to meet certain desired attributes of the distributed storage environment.

This invention generally relates to allowing a user to be able to dynamically define attributes, for example, pertaining to the user or to one or more 3rd parties and, based on those designated attributes, to optimize a configuration, monitor and maintain the configuration attributes as the configuration pertains to both individual storage nodes and the overall storage environment within a distributed data storage system.

Further, this invention generally relates to a system and method which includes a dashboard, decisioning modules, information feeds (e.g., proprietary and 3^{rd} party feed) and configuration modules used in conjunction with a distributed data storage system in order to create a storage environment having an infrastructure or overall performance to match a user's or 3^{rd} party's specific required attributes. These attributes can include quantified risks, mitigation of perceived risks, performance, geographic, and or vendor related attributes. As a result, the present application enables details of the attributes of the distributed data storage system to be effectively, accurately and efficiently communicated between the users and other parties and allows multiple users to collaborate and use the distributed data storage system more effectively.

The present invention further enables users to efficiently and effectively evaluate, configure, monitor and maintain attributes of the storage environment, in addition to enabling a 3^{rd} party to ensure a data storage environment meets a prescribed set of attributes.

These attributes may be defined by the user or may be attributes that have been defined by a 3^{rd} party. The attributes can include any aspect of a data storage environment, its infrastructure, components of the data storage environment, vendors of those components of the data storage environment as well as the geographic location of the components of the data storage environment or the vendors. One of the attributes can be, for example, risk of data loss or risk of data breach. The invention enables the user to not only mitigate the risk but, by utilizing risk assessment mechanisms as found in other industries, to enable a means of quantifying that risk and conveying to a 3^{rd} party and as defined above the assessment, configuration, maintenance and monitoring of the particular quantified risk of an entire distributed storage environment apparatus can be done which has not been possible in this manner heretofore.

More particularly, the present invention can be used for evaluating risk assessments, based on certain user defined risk parameters and/or attribute profiles for distributed data storage systems, which can be based on public cloud resources and/or on-premise private resources. Thereupon the evaluation of the assessments can be used to determine whether a configuration optimization for a distributed data storage system is necessary. Optimization of data storage system configuration can be performed to minimize risk indices and to satisfy client's requirements. Further, risk assessment can be utilized as a component of the data storage system optimizer. The invention may be used by a storage system administrator, by a cloud service provider or by a third party.

This present invention is intended for assessment and configuration optimization. In addition, it includes monitoring to ensure the chosen profile is maintained The invention may be utilized to approximate an over all risk score by utilizing assumed probability factors (defined by the user or third parties) of various risks associated with data storage by calculating a meta score utilizing a weighted value for each factor that is either defined by the user or a third party. This creates an overall score (the result of the sum of the factor values based on the weightings that are defined) which can then be used to evaluate and optimize the distributed data storage system. Based on this evaluation, there can be subsequent system reconfiguration, as well as configuration of a new distributed data storage system.

Optimization of the distributed data storage system configuration can be performed to minimize risk indices and to satisfy client's requirements, where the risk assessment system is utilized as a component of a storage system optimizer.

This process makes it possible to create a distributed data storage environment on the fly, as well as to monitor the maintenance and or related attributes, according to the specific technical requirements of the administrator and or a 3rd party as well as to ongoing basis to the administrator/user(s) and or a 3rd party.

Accordingly, optimizing a distributed data storage system in accordance with the present application includes the steps of: Identifying parameters relevant to the distributed data storage or relevant to or set by a user or owner of said data; Obtaining data for the parameters to define aspects of the distributed data storage or the user or owner of the data; Analyzing the data for the parameters to determine the optimum characteristics of said distributed data storage; and Based on the analyzed data for the parameters initially configuring a distributed data storage system or re-configuring an existing distributed data storage system, wherein distributing data in said distributed data storage system including: separating a data file into multiple discrete pieces, and dispersing the pieces among multiple storage units, wherein no one storage unit has sufficient data to reconstruct the data file.

### BRIEF DESCRIPTION OF DRAWINGS

The invention is illustrated by the following drawings:

FIG. 1 is a block diagram illustrating risk assessment system interacting with a distributed storage system.

FIG. 2 is a block diagram illustrating components of risk assessment system.

FIG. 3 is a block diagram illustrating a part of the invention responsible for storage configuration optimization.

FIG. 4 is a flow chart illustrating the operation of a storage system optimization engine for creation of a new storage system configuration or reconfiguration of an existing storage system according to a client's requirements.

FIG. 5 is a flow chart diagram illustrating the operation of a storage system optimization engine for improvement of an existing storage system configuration by elimination of the weakest points in the system.

FIGS. 6-8 illustrate the manner in which the system operates.

### DETAILED DESCRIPTION OF THE INVENTION

The present application regards optimizing a distributed data storage system and includes the steps of: Identifying parameters relevant to the distributed data storage or relevant to or set by a user or owner of said data; obtaining data for the parameters to define aspects of the distributed data storage or the user or owner of the data; analyzing the data for the parameters to determine the optimum characteristics of said distributed data storage; and based on the analyzed data for the parameters initially configuring a distributed data storage system or re-configuring an existing distributed data storage system. Distributing data in the distributed data storage system can include: separating a data file into multiple discrete pieces, and dispersing the pieces among multiple storage units, wherein no one storage unit has sufficient data to reconstruct the data file.

According to the invention herein, the parameters relevant to the distributed data storage can be selected from the group consisting of node failure, maximum transfer speeds, data sovereignty, power sources, carbon foot print per gigabyte, corporate policies, pricing policies, data exposure, regulatory compliance, geographic concentration, provider concentration, provider, dynamic event response, data breach, or data exposure, as hereinafter described. It should be appreciated that these are illustrative examples and is not intended to be an exhaustive list of all possible parameters. Other relevant parameters may also be used.

Another aspect of the invention is that obtaining data for the parameters to define aspects of the distributed data storage involves obtaining the data from 3^{rd} parties who are proficient in calculating the data.

Further, analyzing the data for the parameters to determine the optimum characteristics of the distributed data storage involves obtaining the analysis from 3^{rd} parties who are proficient in analyzing the data.

The steps of obtaining data and analyzing the data can be, in certain desired situations, continuously performed and based on an updated analysis initially configuring a distributed data storage system or re-configuring an existing distributed data storage system. There may be occasions where the user and/or a 3^{rd} party may require such continuous monitoring.

The invention further includes advising the owner or the user of the data or a 3^{rd} party about initial configuration of a distributed data storage system or re-configuration of an existing distributed data storage system.

In addition, the invention may include initially configuring a distributed data storage system or re-configuring an existing distributed data storage system to maintain a selected parameter at a specified value.

The present invention can be used for evaluating risk assessments and then determining if configuration optimization for a distributed storage system is necessary. It evaluates risk assessments for an existing data storage system and then determines if system reconfiguration is necessary, as well as to configure a new storage system. Optimization of data storage system configuration is performed to minimize risk indices and to satisfy client's requirements. Risk assessment is utilized as a component of the storage system optimizer. The invention may be used by a storage system administrator, by a cloud service provider or by a third party.

This system dynamically creates and monitors data storage environments (such as Primary, cloud public/private/hybrid NAS/SAN or archive) so that they meet specific user requirements, relating to specific attributes such as node failure, data breach, geographic exposure risk, Data Sovereignty, infrastructure provider type, etc. For example, there can be an interface control store data dynamically to meet varying needs of tolerances of the probability of risk to loss of data stored.

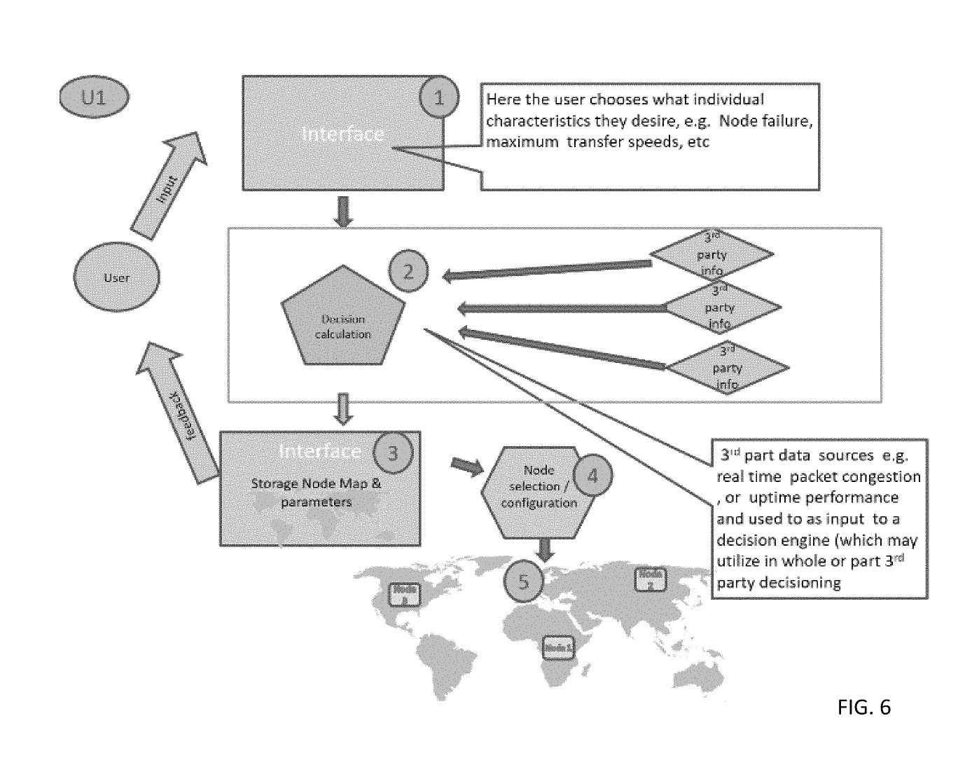

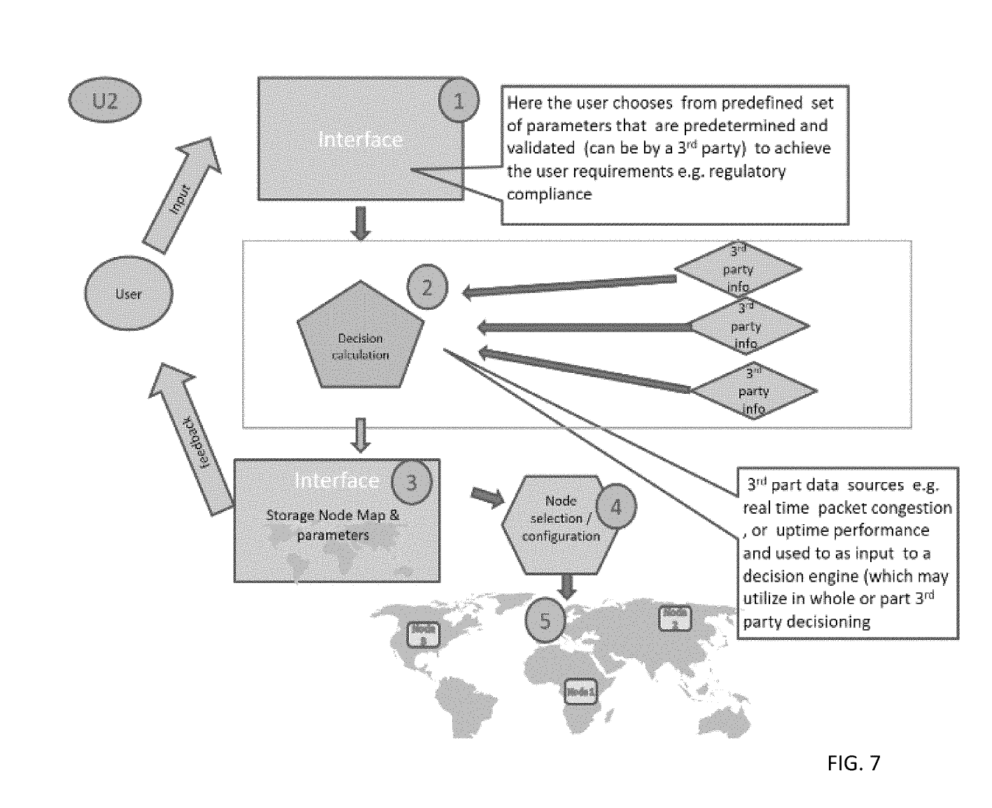

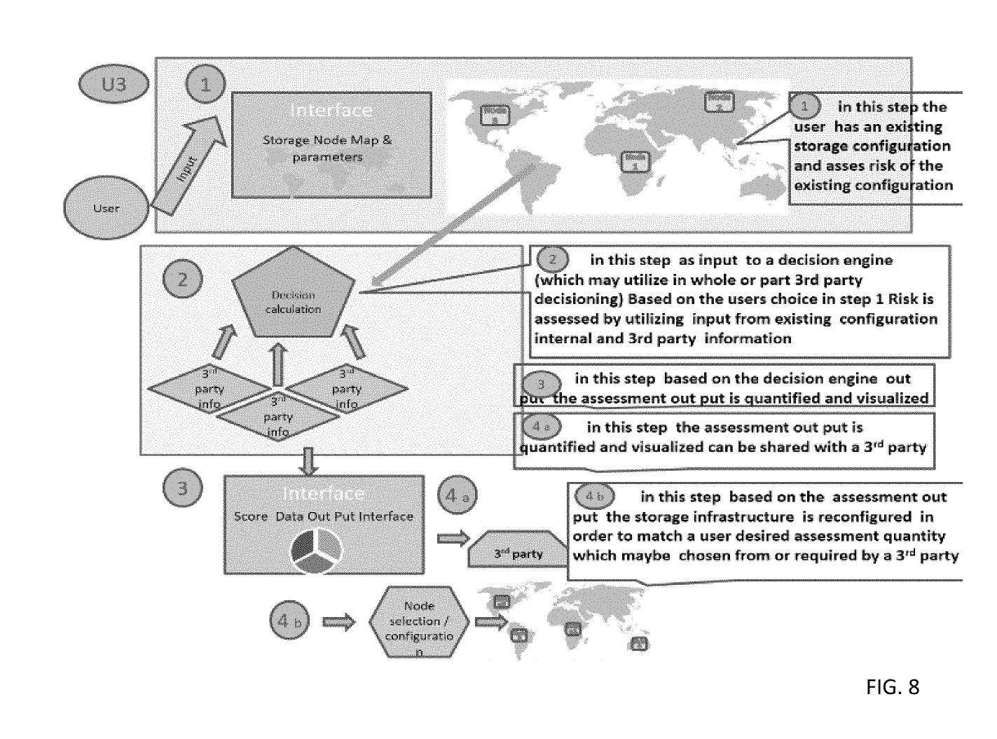

FIGS. 6-8 depict how the system operates with respect to different types of users. As shown in FIG. 6, a user chooses various individual parameters according to particular requirements. FIG. 7 depicts a user that chooses various profiles that are a predefined set of parameters (which may be from and/or required by a 3^{rd} party). In FIG. 8, there is depicted a user with a preexisting storage configuration that it wants to rate and may then want to reconfigure.

As illustrated and depicted in FIG. 6, in the Interface 1 the user chooses which individual characteristics are relevant and important for its data storage system. Among the possible characteristics include node failure, maximum transfer speeds, data sovereignty, power sources, carbon foot print per gigabyte, corporate policies, pricing policies or data exposure. At the decision calculation step 2, information is received from various 3^{rd} parties. In particular, 3^{rd} party data data, for instance real-time packet congestion, or uptime performance are input to a decision engine (which may utilize in whole or part 3^{rd} party decisioning). Interface 3 maintains a map showing the various data storage nodes and their locations. Based on the evaluation of the information, at Step 4 a new optimized configuration 5 of the nodes is presented. This suggested new configuration can either be automatically implemented with appropriate reconfiguration of the existing node configuration, or the optimized configuration may be simply presented to the user as feedback as something desirable to do.

The process in FIG. 7 is similar to the FIG. 6 process. Here a user chooses from a predefined set of parameters that are predetermined and validated (can be by a 3^{rd} party) to achieve certain user requirements e.g. regulatory compliance, geographic concentration, provider concentration, provider, dynamic event response, data breach, or data exposure. After this initial step, the process is basically the same as the process of FIG. 6.

FIG. 8 depicts a reverse type of situation. In Interface 1, a map of the data storage nodes is shown including node locations. In this step, the user has an existing storage configuration and wants to assess risk of the existing configuration. Here, too, the decision calculation 2 receives information from 3^{rd} parties. In this step, there is input to a decision engine (which may utilize in whole or part 3rd party decisioning). Based on the users choice in step 1, risk is assessed by utilizing input from existing configuration internal and 3rd party information. Based on the decision engine output, the assessment output is quantified and visualized. The assessment output is quantified and visualized and can be shared with a 3^{rd} party when appropriate. Another Interface evaluates the information. Based on the assessment output, the storage infrastructure is reconfigured in order to match a user desired assessment quantity which may be chosen from or required by a 3^{rd} party. The result in 4b may be to automatically reconfigure the data storage node configuration, or to at least suggest the new configuration to the user.

The distributed data storage aspect of the herein disclosed invention involves separating the data into discrete pieces and then storing the discrete pieces in multiple storage nodes, as shown in FIGS. 6-8 herein.

Applicant hereby incorporates by reference herein the entire disclosure, including, but not limited to, the Specification, Drawings, and Claims, of its International applications PCT/US2015/030163 (published as WO/2015/175411) and PCT/US17/22593. These applications disclose a distributed data storage system which may be utilized with the herein disclosed invention.

A particular data storage embodiment involves separating a media data file into multiple discrete pieces, erasure coding these discrete pieces, and dispersing those pieces among multiple storage units, wherein no one storage unit has sufficient data to reconstruct the data file. A map is generated, showing in which storage units each of the discrete pieces of the data file is stored. In particular, a unique identifier is assigned to each discrete piece and a map of the unique identifiers is used to facilitate the reassembly of the data files.

These international applications disclose a cloud storage technology for streaming media files, which breaks up each data file into file slice fragments which are stored on a series of cloud servers, that are preferably dispersed among different geographical locations. In an embodiment, client enterprise media data is disassembled into file slice fragments using object storage technology. All the resulting file slice fragments are encrypted, and optimized for error correction using erasure coding, before dispersal to the series of cloud servers. This creates a virtual “data device” in the cloud. The servers used for data storage in the cloud can be selected by the client to optimize for both speed of data throughput and data security and reliability. For retrieval, the encrypted and dispersed file slice fragments are retrieved and rebuilt into the original file at the client's request. This dispersal approach creates a “virtual hard drive” device in which a media file is not stored in a single physical device, but is spread out among a series of physical devices in the cloud which each only contain encrypted “fragments” of the file. Access of the file for the purposes of moving, deleting, reading or editing the file is accomplished by reassembling the file fragments rapidly in real time. This approach provides numerous improvements in speed of data transfer and access, data security and data availability. It can also make use of existing hardware and software infrastructure and offers substantial cost reductions in the field of storage technology.

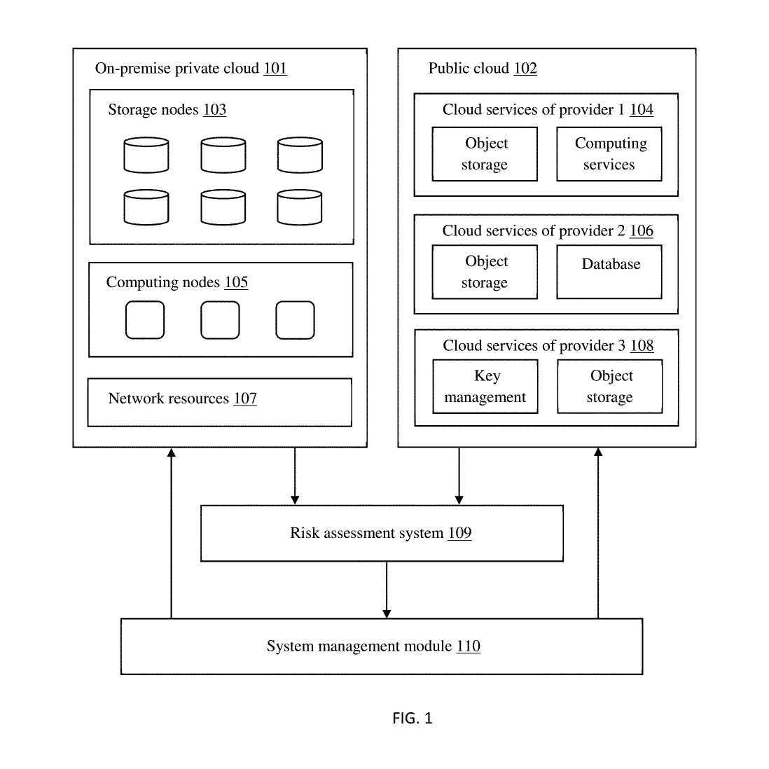

FIG. 1 is a block diagram illustrating a risk assessment system interacting with a distributed data storage system. Risk assessment system 109 performs computation of risk indices for a distributed data storage system and its components, where computations are based on information about on-premise private cloud 101 and public cloud 102 components. Results of risk assessment are processed by system management module 110. Obtained risk indices may be employed not only for informational purposes, but also to improve the data storage system configuration.

The present invention may be employed for a distributed data storage system comprising both on-premise private cloud resources 101 and public cloud resources 102. Risk evaluation for on-premise private cloud resources 101 is based on risk estimates for storage nodes 103, computing nodes 105 and network resources 107. Information about on-premise private cloud resources 101 is available to a storage system administrator and additional measurements can be performed on demand. Risk estimate for storage nodes 103 depends, for example, on the number of disks (e.g. HDD and SSD), annual disk failure rate (which depends on technical characteristics of the disks and the workload that is disk usage), and the time required for disk replacement. Risk estimate for computing nodes 105 depends on the number of servers, failover rate (the number of servers which can fail without significant loss in performance), the annual failure rate for servers and their components, and the time required to replace server's component in case of failure. Risk estimate for network resources 107 depends on the types of employed communication lines, their length and topology, as well as annual failure rates for parts of communication lines and recovery time.

Access to public cloud resources 102 is sometimes arranged using, for example, a formal Service Level Agreement (SLA). Cloud service providers try to maximize Quality of Service (QoS) and to minimize the number of SLA violations. Information about SLA is employed to compute public cloud risk estimates, and other statistics given by public cloud provider may be also utilized. Public cloud resources may also refer to a global view of Internet performance anomalies, live weather reports, or other resources.

A variety of cloud services may be used, such as, for example, object storage and computing services of provider 1 104, object storage and database of provider 2 106, key management service and object storage of service provider 3 108. Risk estimate for each cloud service is based on scores given by corresponding cloud service providers.

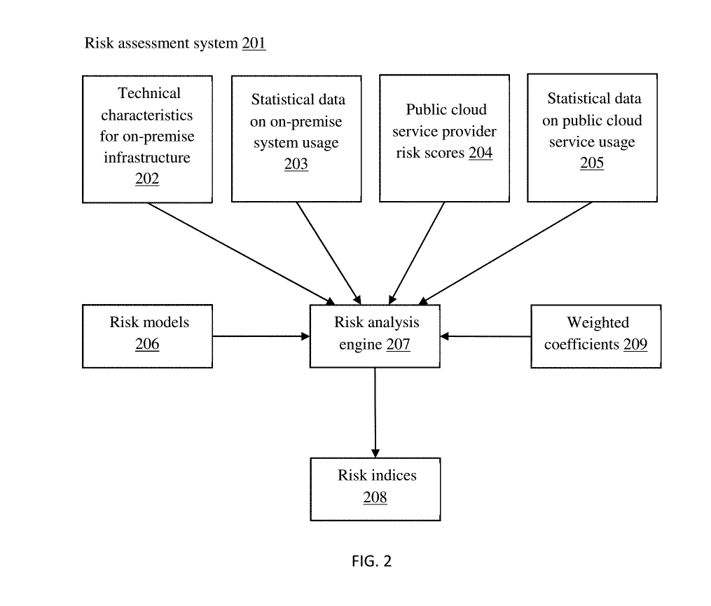

FIG. 2 is a block diagram illustrating components of a risk assessment system. Risk assessment system 201 performs risk analysis for components of a distributed data storage system. Risk analysis engine 207 returns a number of risk indices 208, including an overall risk index together with indices for different risk categories and for a variety of components. Computations are performed according to one of several risk models 206, where weighted coefficients 209 are utilized in order to take into account the relative importance of different risk categories and their attributes. Input arguments include technical characteristics for on-premise infrastructure 202, statistical data on on-premise system usage 203, public cloud service provider risk scores 204 and statistical data on public cloud service usage 205. Weighted coefficients 209 for risk models 206 may be provided as an input argument, or alternatively default values of weighted coefficients are utilized. Technical characteristics of hardware devices are employed, for example, to estimate corresponding annual failure rates. Failure rates for public cloud services are based on scores given by service providers. Statistical data on on-premise resources and public cloud resources are employed to adjust obtained risk indices. Adjustment of risk scores may be implemented using machine learning methods. Statistical data may be gathered by a monitoring module of the distributed data storage system and/or provided by a third party.

The following categories of cloud service provider's risk are among the ones that may be considered during analysis:
Data risk is related to operations with data stored at a provider's site. Computation of data risk includes analysis of an employed encryption algorithm, replication and/or erasure coding method and other operations performed with data by cloud service provider.
Data transfer risk is caused by use of unreliable network. Data transfer risk depends on the utilized authentication method, threat and vulnerability practices, structure of transferred data and etc.
Malicious client risk is a risk of harmful operations performed by a client of the cloud service provider. This risk depends on measures taken to segregate data of different clients and to check a client's identity. Usage of anonymous practices increases the number of possible attacks by malicious clients, while multi-factor authentication decreases malicious client risk.
Business risk is the possibility a company will have significantly lower than anticipated profits or experience a loss rather than taking a profit. Business risk depends on the provider's operational practices, provider's auditing practices, compliance certifications and etc. Risk of rising prices is also included in business risk category.
Legal risk is the risk arising from a cloud service provider's failure to comply with statutory or regulatory obligations. Legal risk category includes, for example, risk from changes of jurisdiction, data protection risks and licensing risks.

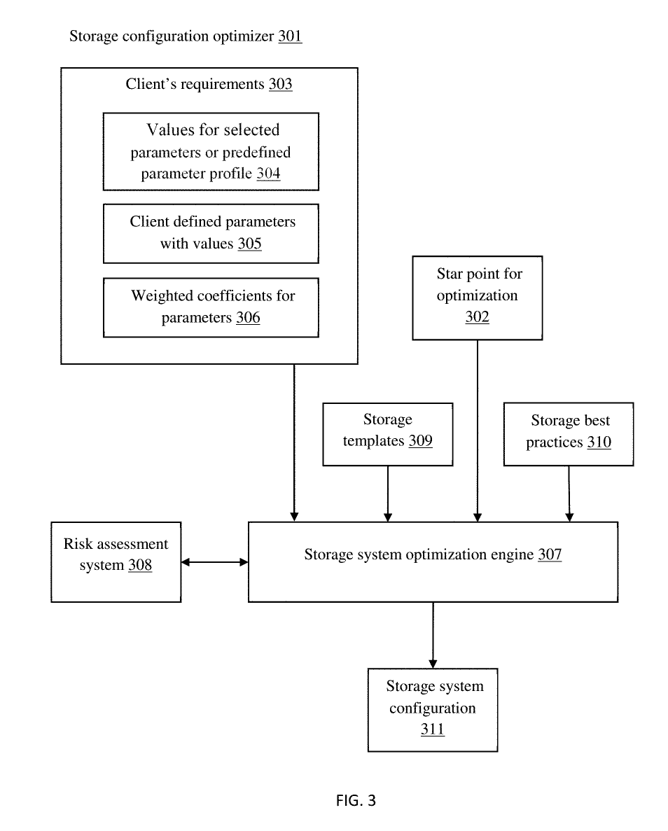

FIG. 3 is a block diagram illustrating the part of the invention responsible for storage configuration optimization. Storage system optimizer 301 utilizes risk assessment system 308 as a component. Storage system optimization engine 307 performs a search for a storage system configuration 311, such that client's requirements 303 are satisfied and risk indices are minimized. Risk assessment system 308 is used to obtain risk estimates for possible storage system configurations belonging to the search space. Client's requirements 303 are represented as a list of parameters with corresponding values. Client's requirements 303 comprise standard parameters 304 and client defined parameters 305. A client may select values for a number of standard parameters, while values of other parameters will be identified during optimization of configuration. Alternatively, one of predefined parameter profiles may be utilized to achieve regulatory compliance. Client defined parameters 305 are functions such that standard parameters employed as variables, where formulas for functions are selected by the client. Client defined parameters 305 are optional. Standard parameters are known to be important for a storage system, while client defined parameters are needed to satisfy preferences of a particular client. Weighted coefficients for parameters 306 are selected for parameters with assigned values, where each weighted coefficient shows relative significance of a parameter.

Initial storage solution may be given as a starting point for optimization 302. Alternatively, this argument may be skipped. Storage templates 309 are utilized as a set of already optimized solutions for components of a storage system. Storage best practices 310 are also employed to improve storage system solution.

The following is an example of a client's requirements, utilized by a storage system optimization engine as input argument. This enables creation of a new storage environment based on a preset profile of risk attributes.

| | TYPE | Value | Weighting |
|---|---|---|---|
| A | Geographic profile | 10 | 20% |
| B | Geographic concentration | 9 | 25% |
| C | Provider Type | 6 | 15% |
| D | Provider concentration | 10 | 25% |
| E | Dynamic event response | 5 | 10% |

The user, therefore, needs to create a data storage environment whose risk weighting matches the values above.

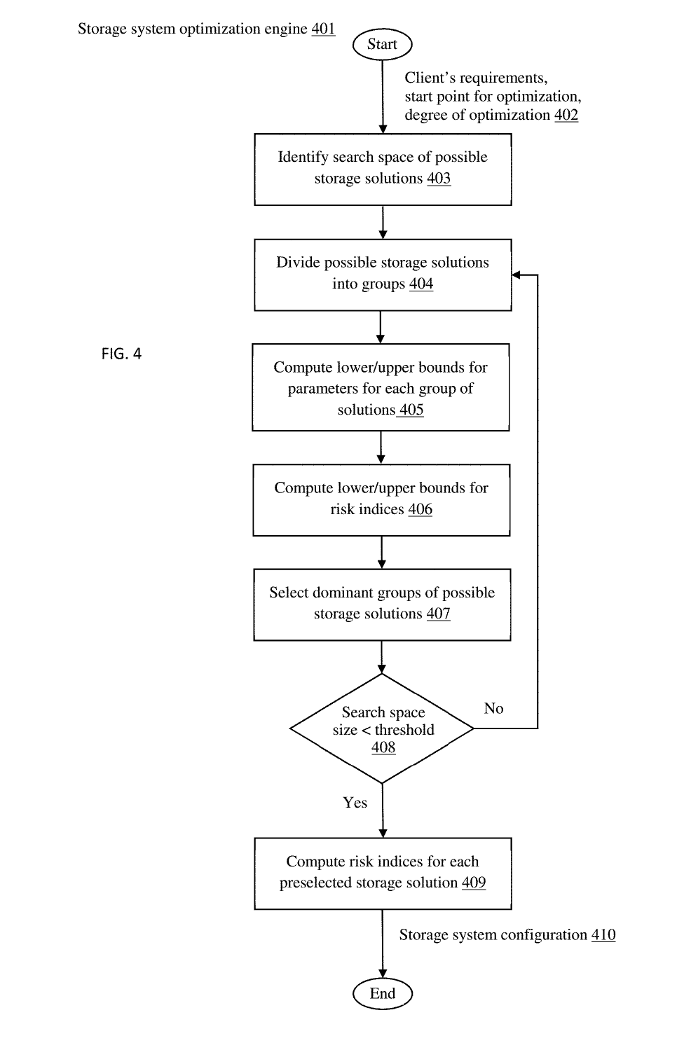

FIG. 4 is a flow chart illustrating the operation of a data storage system optimization engine for creation of a new data storage system configuration or reconfiguration of an existing data storage system, according to a client's requirements. Storage system optimization engine 401 performs a search over possible storage system configurations and identifies configuration with the smallest values of risk indices. Possible storage configurations are storage configurations satisfying client's requirements. Size of the search space can be iteratively reduced by elimination of groups of untenable storage solutions (solutions with highest bounds on risk indices). For reconfiguration of an existing system, the degree of optimization is specified as an input argument.

Storage system optimization engine 401 receives the client's requirements, and is the start point for optimization and degree of optimization 402 as input arguments. Current storage configuration or a configuration template may be utilized as a start point of optimization. This is an optional argument and may be skipped. Degree of optimization is required only in case of reconfiguration of existing storage system. A low value of degree of optimization corresponds to local optimization and relatively small search space, while a high value of degree of optimization corresponds to creation of a new storage system configuration. At step 403 a search space of all possible storage solutions, satisfying client's requirements, is identified. At step 404 current search space is divided into groups of storage solutions, where different groups correspond to different ranges of values of parameters. At step 405 lower and/or upper bounds for parameters are identified for each group of solutions. At step 406 a lower and/or upper bound is computed for risk indices for storage solutions from the same group. Search space is reduced at step 407 by focusing on dominant groups of possible storage solutions and elimination of all other groups. If at step 408 the total number of storage solutions within current search space is lower than a predefined threshold, then precise values of risk indices are computed for each solution within current search space at step 409. Otherwise, current search space is further divided into groups of smaller size at step 404. Finally, the best storage system configuration 410 is obtained.

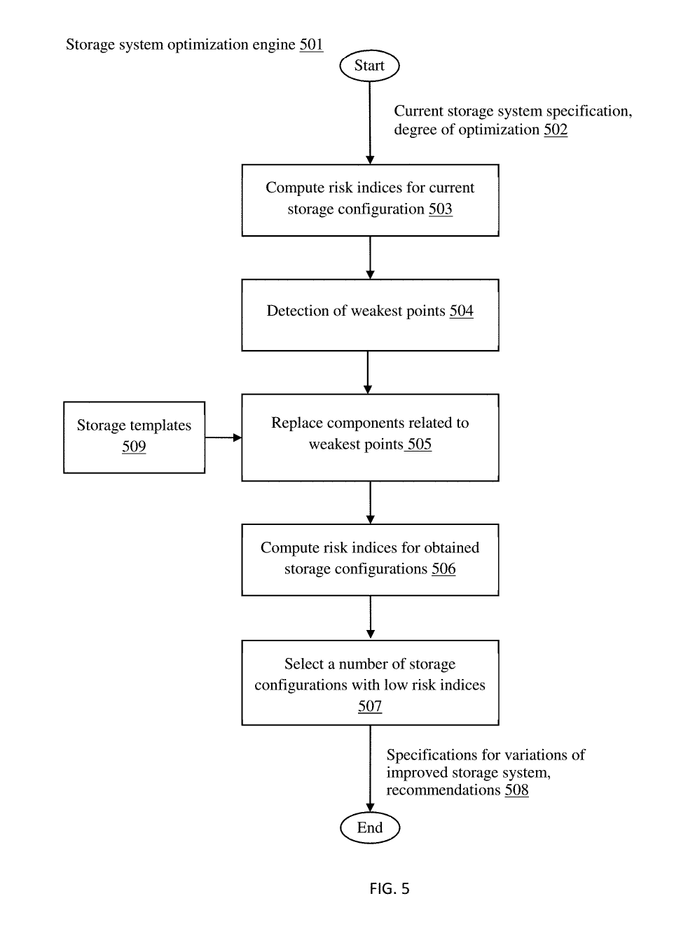

FIG. 5 is a flow chart illustrating operation of a data storage system optimization engine for improvement of an existing storage system configuration by elimination of the weakest points in the system. For reconfiguration of a data storage system, optimization engine 501 receives specification of current storage system and degree of optimization 502 as input arguments. Here the degree of optimization is used to define size of search space, more precisely, ranges of considered values of parameters.

At step 503 assessment of current storage system is performed and corresponding risk indices obtained. Intermediate computation results are further employed to detect the weakest points of the system at step 504. Local optimization of desired degree is performed for components related to the weakest points at step 505. Storage templates 509 are utilized as a set of precomputed solutions for component replacement. A set of possible improved storage configurations is obtained as a result of a number of local optimizations. At step 506 risk indices are computed for storage configurations from the set obtained at step 505. Then at step 507 one or several storage system configurations with lowest risk indices are selected. Specifications for variations of improved storage system and optional recommendations 508 are provided to the client.

One aspect of the invention is assessing a value for an existing data storage environment. In particular, the storage administrator assesses the score of an existing storage environment to see how compatible it is with a certain user's requirements.

| | Profile Name | Compliance |
|---|---|---|
| 1 | MilSpec No-Loss | DOD, USAF, USMC |
| 2 | UpTimeUpTown | Retail, PII |
| 3 | Fast and Furious Latency | CDIA |
| 4 | The Day After Data | US Gov |
| 5 | Dynamic | Union of apps |

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

We claim:

1. A method for optimization of a distributed data storage system, comprising the steps of:
A. identifying parameters relevant to said distributed data storage or relevant to or set by a user or owner of said data;
B. obtaining data for said parameters to define aspects of said distributed data storage or said user or owner of said data;
C. analyzing said data for said parameters to determine the optimum characteristics of said distributed data storage; and
D. based on said analyzed data for said parameters initially configuring a distributed data storage system or re-configuring an existing distributed data storage system, wherein distributing data in said distributed data storage system including: separating a data file into multiple discrete pieces, and dispersing said pieces among multiple storage units, wherein no one storage unit has sufficient data to reconstruct the data file.

2. A method according to claim 1 wherein said parameters relevant to said distributed data storage being at least one selected from the group consisting of node failure, maximum transfer speeds, data sovereignty, power sources, carbon foot print per gigabyte, corporate policies, pricing policies, data exposure, regulatory compliance, geographic concentration, provider concentration, provider, dynamic event response, data breach, and data exposure.

3. A method according to claim 1 wherein obtaining data for said parameters to define aspects of said distributed data storage involves obtaining said data from third parties.

4. A method according to claim 1 wherein analyzing said data for said parameters to determine the optimum characteristics of said distributed data storage includes obtaining said analysis from third parties.

5. A method according to claim 1 wherein the steps of obtaining data and analyzing said data are continuously performed and based on an updated analysis initially configuring a distributed data storage system or re-configuring an existing distributed data storage system.

6. A method according to claim 1 further comprising advising said owner or said user of said data or a third party about initial configuration of a distributed data storage system or re-configuration of an existing distributed data storage system.

7. A method according to claim 1 further comprising initially configuring a distributed data storage system or re-configuring an existing distributed data storage system to maintain a selected parameter at a specified value.

8. A method according to claim 1 further comprising advising said owner or a user of said data or a third party about an ongoing status of said distributed data storage system or re-configurations of said distributed data storage system in order to maintain a selected parameter at a specified value on an ongoing basis.
